(19) United States
(12) Patent Application Publication
(10) Pub. No.: US 2008/0233303 A1
(43) Pub. Date: Sep. 25, 2008

(54) Coatings for metal-metal seal surfaces

(75) Inventors: Xiangyang Jiang, Dunlap, IL (US); Kevin Nemec, Franklin, NC (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/153,741

(22) Filed: May 23, 2008

Related U.S. Application Data
(62) Division of application No. 11/216,854, filed on Aug. 31, 2005, now abandoned.

(51) Int. Cl. B05D 1/18

(52) U.S. Cl. 427/443.1

(57) ABSTRACT

A method of producing a metal seal ring is provided. The method includes selecting a seal ring substrate material and applying a coating to the seal ring substrate material using an electroless plating process.

### TECHNICAL FIELD

This disclosure pertains generally to metal-metal face seals, and more particularly, to metal-metal face seals with protective coatings.

### BACKGROUND

Metal-metal face seals are used in many types of industrial equipment including trucks and track-type machines. These seals are designed to protect underlying components, such as bearings, by keeping out debris and by preventing leakage of protective lubricants. Such machines typically operate in environments that are highly destructive to seals and consequently to the underlying bearings. As a result, they must be resistant to corrosion and be able to withstand heavy loads, high velocities, increased temperatures, and harmful effects of dirt and debris.

Metal seals have greatly improved track roller bearing life. However, while satisfactory for the normal operation of the average track-type machine or truck, current metal face seals have some drawbacks when applied to large high speed trucks and track machines. For example, when the seal diameter gets large, the surface velocity at the seal face increases, which produces problems due to increased heat and radial forces. In addition, under some conditions, dirt and debris can enter at the seal face. This dirt and debris increases the coefficient of friction between seal faces, thereby further damaging seal surfaces.

One type of metal-metal face seal is disclosed in WO 01/33117 to Hoefft and published on May 10, 2001 (hereinafter the Hoefft publication). This publication provides a metal-metal seal assembly having a first metal seal ring with a substantially flat sealing surface, a first predetermined hardness, and a predetermined width. The Hoefft publication further provides a second metal seal ring that mates with the flat sealing surface and has a second predetermined hardness that is lower than the surface hardness of the first metal seal ring.

Although the face seals of the Hoefft publication may be suitable for some applications, the face seals of the Hoefft publication may have some disadvantages. For example, the Hoefft face seals may require the use of a variety of coating materials such as ceramic borides, nitrides, and diamond-like carbons. These materials can provide durable and wear-resistant materials for some face seals. However, these materials may be expensive or difficult to produce. Further, other coating materials may provide even better face seals for some applications.

The presently disclosed system is directed to overcoming one or more shortcomings in currently available seals.

### SUMMARY OF THE INVENTION

One aspect of the present disclosure includes a method of producing a metal seal ring. The method may include selecting a seal ring substrate material and applying a coating to the seal ring substrate material using an electroless plating process.

A second aspect of the present disclosure includes a metal seal ring. The seal ring may include a metal seal ring substrate and a nickel-boron coating disposed on a surface of the metal seal ring substrate.

A third aspect of the present disclosure includes a metal seal ring. The seal ring may include a metal seal ring substrate and a nickel-phosphorous coating disposed on a surface of the metal seal ring substrate.

A fourth aspect of the present disclosure includes a metal seal ring assembly. The assembly may include a first metal seal ring substrate, a second metal seal ring substrate, and a coating disposed on a surface of at least one of the first metal seal ring substrate and the second metal seal ring substrate. The coating may include at least one of a nickel-phosphorous coating and a nickel-boron coating.

### BRIEF DESCRIPTION OF THE DRAWINGS

FIG. 1 illustrates a wheel station including a metal-metal face seal, according to an exemplary disclosed embodiment.

FIG. 2A provides a perspective view of a metal-metal seal ring assembly, according to an exemplary disclosed embodiment.

FIG. 2B provides a cross-sectional view of the metal-metal seal ring assembly of FIG. 2A.

FIG. 3 provides a side view of another metal-metal face seal, according to an exemplary disclosed embodiment.

FIG. 4 provides an optical micrograph of a nickel-boron coating, according to an exemplary disclosed embodiment.

### DETAILED DESCRIPTION

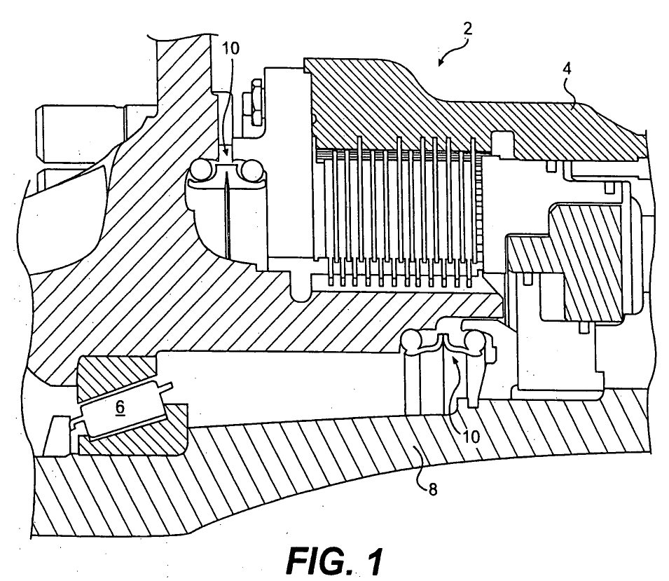

FIG. 1 illustrates a wheel station 2 including two metal-metal seal ring assemblies 10, according to an exemplary disclosed embodiment. Wheel station 2 further includes a wheel station housing 4, at least one bearing 6, and a wheel shaft 8. A lubricant may be contained within the wheel station 2. Seal ring assemblies 10 may be configured to prevent leakage of lubricant from wheel station 2. Further, seal ring assemblies 10 will also prevent dirt and debris from entering wheel station 2 and potentially damaging bearings 6, wheel shaft 8, surfaces of the seal rings, or other components of wheel station 2.

As shown, seal ring assemblies 10 represent Duo-Cone seal rings, as produced by Caterpillar Inc. Further, seal ring assemblies 10 are shown on a wheel station 2. However, seal ring assemblies 10 of the present disclosure can include any seal ring design and may be used in a variety of different work machines or work machine components. For example, seal ring assemblies 10 of the present disclosure may be used in work machines such as tractors, pumps, augers, scrapers, axles, skidders, backhoes shovels, classifiers, ski lifts, tractors, conveyors, transporters, drill rigs, trucks, excavators, tunneling machines, graders, wagons, haulers, railway equipment, loaders, and military vehicles. Further, seal ring assemblies 10 of the present disclosure may be used in a variety of different machine components, including axles, final drive applications, wheel applications, and undercarriage applications. In addition, ring assemblies 10 may include any metal-metal seal ring size, design, or configuration, including for example, Heavy Duty Dual Face seals.

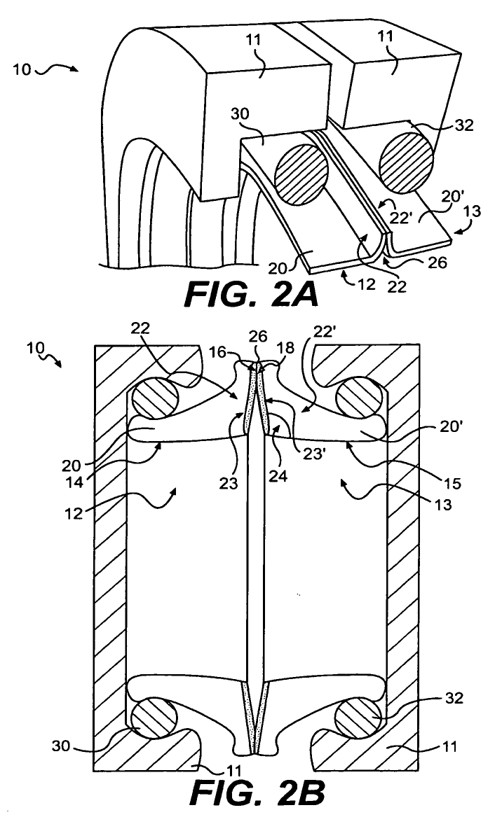

FIGS. 2A and 2B illustrate more detailed views of seal ring assembly 10, according to an exemplary disclosed embodiment. FIG. 2A provides a perspective view of a portion of seal ring assembly 10, and FIG. 2B provides a cross sectional view of seal ring assembly 10, as shown in FIG. 2A. As shown, seal ring assembly 10 includes first and second metal seal rings 12, 13. Each seal ring 12, 13 can include a coating 16, 18 disposed on a surface 23, 23′ of a ring substrate 14, 15. Coatings 16, 18 can provide increased hardness and/or wear resistance at a seal ring interface 26.

Seal rings 12, 13 can have a number of suitable designs. Generally, metal-metal seal rings have a first section 20, 20′ and a second section 22, 22′. First section 20, 20′ and second section 22, 22′ are oriented at a certain angle 24 with respect to one another, and as shown, second section 22 of one seal ring 12 is configured to engage second section 22′ of second seal ring 13 at seal interface 26. In some embodiments, coatings 16, 18 will be disposed on surfaces 23, 23′ of seal ring second sections 22, 22′, which correspond to seal interface 26.

It should be noted that seal ring designs may vary. For example, in some designs, angle 24 between first section 20, 20′ and second section 22, 22′ will be about 90°, but may between 90° and 110°. In addition, in some embodiments, surface 23, 23′ at interface 26 may be flat or have a variety of curved surface shapes. The specific surface shape may be selected based on the ring application, cost, coating type, or any other suitable factor.

Seal ring assembly 10 may be contained in a seal ring housing 11 and may further include one or more torics 30, 32. As shown, housing 11 includes a representative housing design, but any suitable housing 11 may be selected depending on the ring design, size, and application. Further, torics 30, 32 can be produced from a variety of suitable rubber or elastomeric materials and may be configured to secure seal rings 12, 13 within housing 11. Torics 30, 32 may also produce a fluid-tight seal between housing 11 and seal rings 12, 13.

As noted, torics 30, 32 may be produced from a variety of different rubber or elastomeric materials. The toric elastomeric materials may be selected to have a suitable compressibility to form a secure seal with adjacent metal components. Toric materials may also be selected to withstand a certain degree of heat or friction produced by adjacent or nearby components. Suitable toric materials may include, for example, nitrile, low-temperature nitrile, various silicones, hydrogenated nitrites, and/or various fluoroelastomers.

Ring substrates 14, 15 can be made with a number of suitable materials. For example, suitable ring substrates 14, 15 may be made from a number of different steels or other metals. The specific steel or other metal may be selected based on desired physical properties, including hardness, toughness, wear resistance, or other desired properties. Suitable ring substrate materials may also be selected based on a number of other factors, including bondability with coatings 16, 18, cost, machinability, or any other suitable factor. Ring substrates 14, 15 may be fabricated by forging or precision casting followed by machining to a desired size and shape.

Coatings 16, 18 may be produced using a number of suitable processes and materials. In one embodiment, coatings 16, 18 may be produced using an electroless plating process. Electroless plating, also known as autocatalytic plating, involves material deposition without the use of an electric current. Generally, electroless plating includes catalytic reduction of one or more metal ions in a solution to deposit the metal on a surface without electrical energy. The driving force for the deposition process is provided by a chemical reducing agent in solution.

In some embodiments, coating 16, 18 will include a nickel-based material. Suitable nickel-based materials can include, for example, nickel-boron (Ni—B) and nickel phosphorous (Ni—P). Ni—B and Ni—P coatings can be produced using a variety of known electroless plating processes.

A variety of suitable electroless plating processes may be used to produce a suitable coating. Generally, suitable plating processes will begin by pretreating or cleaning a substrate surface. A variety of pretreatment or cleaning processes may be selected. The specific pretreatment or cleaning process may be chosen based on the substrate being coated, the type of coating material being applied, desired speed, cost, or any other suitable factor. Suitable pretreatment or cleaning processes may include combinations of solvent washing, rinsing degreasing, and electrocleaning. Further, some substrates may also require chemical activation to facilitate electroless plating. Any suitable pretreatment or cleaning process may be selected.

After pretreatment or cleaning, electroless plating may be performed using a plating solution. The solution will include a solvent (eg. water), ions of one or more metals to be plated on a substrate material, and a reducing agent. The metal ions will be provided using, for example, a metal salt that is at least partially soluble in the solution solvent. In the case of nickel, the metal salt may include, for example, nickel chlorides, nickel sulfates, nickel formates, nickel acetates, and/or any other suitable nickel salt that is soluble in the solution. In some embodiments, the salt may be selected such that the salt anions will not interfere with the electroless plating process or will not produce undesired coating properties.

A variety of suitable reducing agents may be used. For example, to produce a Ni—B coating, N-dimethylamine borane (DMAB), H-diethylamine borane (DEAB), or sodium borohydride may be selected as reducing agents. To produce a Ni—P coating, sodium hypophosphite may be selected. The specific reducing agent and reducing agent concentration may be selected based on a number of factors. For example, the reducing agent type and reducing agent concentration may be selected to control the amount of boron or phosphorous in a coating. Further, the reducing agent may be selected based on a desired speed of the plating process, cost, or any other suitable factor.

Suitable coating solutions may also contain a variety of additives. For example, suitable additives may be selected to control the pH of the solution, to stabilize metal ions, to prevent precipitation of metal salts, to control the free metal ion concentration, or to control certain physical properties of the coating.

In some embodiments, one or more additives may be selected to control the solution pH. A range of suitable pHs may be selected, and the specific pH may be chosen to control the plating process speed or final coating composition. In addition, the pH of the plating solution may be chosen based on the type of reducing agent being used. In some embodiments, the solution may contain an acidic pH. In other embodiments, the solution may contain an alkaline pH. Further, a number of different acids or bases may be selected to control the pH of a plating solution. Such acids and bases may include, for example, strong acids or strong bases, such as sodium hydroxide or hydrochloric acid. Any suitable acid or base may be selected.

In one embodiment, a suitable plating solution can include one or more complexing agents. Suitable complexing agents may be selected to control the free nickel ion concentration of a nickel electroless plating solution. These complexing agents can include various organic acids or their salts. Such agents can include, for example, lactic acid, propionic acid, glutaric acid, or any other suitable organic acid. The type and concentration of selected complexing agents may affect the speed of the deposition process. In addition, certain complexing agents may be selected to control residual stresses and/or other physical properties of plated coatings.

A desired coating may be produced by submerging a substrate in a suitable coating solution. During the coating process, the temperature and pH of the coating solution may be monitored and controlled. In some embodiments, the coating solution will be held at a constant temperature. In other embodiments, the solution will initially be heated to initiate the catalytic plating process. Further, the coating time will be selected to produce a coating with a certain thickness. For example, suitable metal-metal face seal coatings may have a thickness between about 10 micrometers and 250 micrometers.

Coatings 16, 18 can have a range of suitable compositions. For example, suitable Ni—B coatings may have a range of suitable boron concentrations. In some embodiments, suitable Ni—B electroless plated coatings will include between about 1% and about 10% boron by weight, between about 1% and about 8% boron by weight, between about 4% and about 7% boron by weight, between about 5% and about 6% boron by weight. Further, suitable Ni—P coatings may have a range of suitable phosphorous concentrations. In some embodiments, suitable Ni—P electroless plated coatings will include between about 1% and about 15% phosphorous by weight, between about 1% and about 12% phosphorous by weight, between about 1% and about 10% phosphorous by weight, or between about 1% and about 5% phosphorous by weight. The specific boron or phosphorous concentration may be selected based on desired coating properties including, for example, hardness, malleability, wear resistance, fracture toughness, friction coefficient with certain materials, corrosion resistance, bondability with base ring substrates, and/or any other suitable factor.

In some embodiments, one or more additives may be selected to produce a coating having certain physical properties. For example, some additives may be selected to produce a coating having a certain coefficient of friction or resistance to wear. Such additives may include, for example, solid lubricants and hard particulates. Suitable solid lubricants can include, for example, polytetrafluoroethylene, graphite and molybdenum sulfide. In addition, various carbides (e.g. silicon carbide, chrome carbide), nitrides, borides, diamond, and/or oxides may be incorporated into coatings 16, 18 to produce a harder, more wear resistant coating. Any suitable solid lubricant and hard particulate may be used.

In some embodiments, solid lubricants or hard particulates may be incorporated into coatings 16, 18 during an electroless deposition process. For example, solid lubricants or particulate materials may be provided as powder, which may be suspended in a coating solution. During a coating deposition process, some of the suspended material may be incorporated into coatings 16, 18, thereby producing desired physical properties. In some embodiments, a solid lubricant or hard particulate material may comprise up to 20% by volume of the coating 16, 18.

Coatings 16, 18 may be included on a number of different sections of ring substrates 14, 15. For example, in some embodiments, it may be desirable to limit coating coverage to certain sections of ring substrates 14, 15. Limiting coverage to certain sections of ring substrates 14, 15 may reduce cost for metals such as nickel. To limit coating deposition to certain sections of ring substrates 14, 15 a number of procedures may be used. For example, in some embodiments, the specific regions of ring substrates 14, 15 that are to be coated may be defined by masking other sections of ring substrates 14, 15 during a selected plating process.

As shown in FIG. 2, coatings 16, 18 are disposed on opposing surfaces 23, 23′ of ring substrates 14, 15 at seal interface 26. In this way, coatings 16, 18 will provide a hard, wear resistant surface to portions of seal rings 12, 13 that may be subject to certain degrees of wear and abrasion.

Further, in some embodiments, it may be desirable to have sections of ring substrates 14, 15 which have a softer surface or have a higher friction coefficient. As show in FIG. 2, sections of ring substrates 14, 15 that contact torics 30, 32 are not coated, thereby producing a higher friction coefficient with torics 30, 32. In other embodiments, it may be desirable to limit coating coverage to produce sections of seal rings 12, 13 having a certain degree of flexibility, thereby facilitating formation of an suitable seal or preventing surface fractures.

In other embodiments, it may be desirable to apply coatings 16, 18 to additional sections of ring substrates 14, 15. For example, in some embodiments, coatings 16, 18 may cover the entire surface of ring substrates 14, 15. The extent of coating coverage may be selected based on a number of factors. For example, in some embodiments, it may be easier or faster to coat an entire ring substrate 14, 15 than to mask certain sections of the ring substrate 14, 15.

It should be noted that coating 16 on first seal ring 12 may be different from coating 18 on second seal ring 13. For example, in one embodiment, coating 16 on first seal ring 12 may be produced from a first material having a first hardness and/or wear resistance, and coating 18 on second seal ring 13 may be produced from a material having a second hardness and/or wear resistance. In some embodiments coating 16 on first seal ring 12 may be produced from a coating material having a hardness that is greater than the hardness of coating 18 on second seal ring 13.

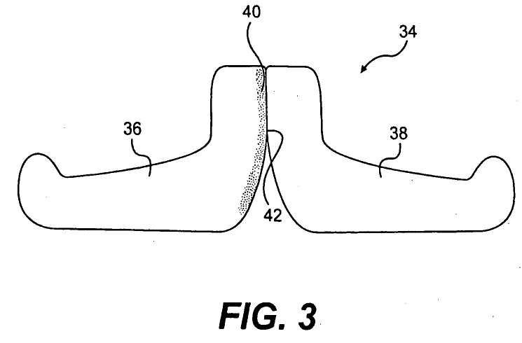

In addition, in some embodiments, it may be desirable to include a coating on one seal ring but not on both seal rings. FIG. 3 provides a side view of another embodiment of a metal-metal face seal 34. In this embodiment, metal face seal 34 includes a first seal ring 36 and second seal ring 38. Further, first seal ring 36 includes a coating 40, and second seal ring 38 does not include a coating. Coating 40 of first seal ring 36 may be produced from a Ni—B or Ni—P material as described above. Further, coating 40 may have a hardness and/or wear resistance which is greater than a hardness or wear resistance of a surface 42 of second seal ring 38.

After applying the coating materials, coatings 16, 18 may be further treated to produce a desired structure and/or physical properties. For example, in some embodiments, coatings 16, 18 may be heat treated to produce desired material properties. Heat treatment may produce a variety of desired changes in material structure and/or physical properties. For example, plated coatings may be substantially amorphous when applied, and heat treatment may crystallize the materials to increase hardness and/or wear resistance. Further, heat treatment may reduce undesired coating stresses and/or improve bonding with underlying substrate materials.

A number of heat treatment processes may be used to treat as-deposited coating materials. For example, in some embodiments, ring substrates 14, 15 and coatings 16, 18 may be annealed in a furnace. Alternatively, coatings 16, 18 may be selectively heat treated using various surface treatments including, for example, arc-lamp heating or laser annealing. The specific annealing time and temperature may be selected to produce a coating having certain structural or physical properties. For example, coatings 16, 18 may be annealed at temperatures between about 150° C. to about 800° C. in a furnace. Further, typical annealing times can be between about 30 minutes and 15 hours, depending on the coating type and desired physical properties. Certain heat-treatments may be selected to produce coatings having a desired degree of crystallinity, to produce certain phase changes within the coating, to produce a certain coating hardness or wear resistance, or for any other suitable purpose.

In some embodiments, it may desirable to anneal coatings during use. During normal use, a certain amount of heating occurs as a result of the friction and load between the metal-metal seal rings. Consequently, as-deposited coating materials may be annealed after installation or by simulating normal use during production. Further, annealing the coating materials in this way may facilitate a small amount of coating deformation or coating wear, which may allow the two seal ring surfaces to form a better seal.

In some embodiments, it may be desirable to polish or clean coatings 16, 18 either before or after heat treatment. Polishing may be accomplished using a number of known polishing techniques. In some embodiments, coatings 16, 18 may be polished to a certain finish. The specific finish may be selected to produce a certain friction coefficient with another metal seal component, for aesthetic purposes, or for any other suitable factor. In some embodiments, a coating may be polished to at least about a 0.5 micrometer finish, to at least about a 0.2 micrometer finish, or to at least about a 0.1 micrometer finish.

### EXAMPLE

### Nickel-boron Metal-metal Face Seal Coating

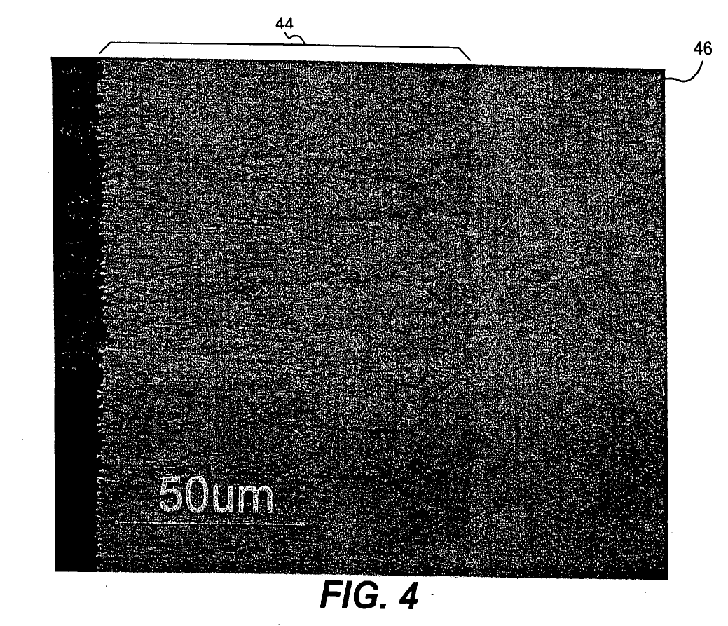

FIG. 4 provides an optical micrograph of a nickel-boron coating 44, according to an exemplary disclosed embodiment. Coating 44 was applied to a mild steel substrate 46 using an electroless deposition process with sodium borohydride as a reducing agent. Coating 44 had a thickness of approximately 50 micrometers.

As deposited, coating 44 had a surface roughness of about 0.6 to about 0.8 micrometers and a Vickers' Hardness (HV) of about 780. Coating 44 was polished to about 0.1 micrometers for use with a metal-metal face seal. Coating 44 was annealed at about 400° C. for 1.5 hour. After annealing, coating 44 had an HV of about 1050.

### INDUSTRIAL APPLICABILITY

The present disclosure provides coatings 16, 18 for metal-metal face seal surfaces. The coatings 16, 18 and seal assemblies 10 of the present disclosure may be used in any application in which metal-metal seal rings 12, 13 are used.

Current seal materials include a variety of hard metals and alloys, such as nihard, C6 (a nickel-chromium-boron alloy), and/or cobalt-based alloys. These alloys are expensive and their durability can be a life-limiting factor for many seal rings. Further, heat generated by the high friction between seal ring components contributes to the setting of rubber toric rings, thereby limiting seal life. The seal rings of the present disclosure include more wear resistant materials with lower friction coefficients. These materials can significantly improve seal ring life, thereby saving significant cost due to repairs, replacements, and machine down time. Further, these materials may be applied to relatively inexpensive seal ring substrates to reduce overall seal ring cost.

The seal ring coatings of the present disclosure may be produced by electroless plating. Electroless plating can provide a number of advantages over other seal ring coating processes. For example, other coating materials, including ceramics and diamond-like carbons, may be expensive or difficult to produce. In addition, using other coating processes, it may be very difficult to produce coatings with adequate thickness for seal ring applications and may need to be machined to an appropriate shape or contour. The electroless Ni—B and Ni—P coatings of the present disclosure can be produced relatively inexpensively, easily, and with suitable thickness for seal ring applications. Further, the metal-metal seal ring coatings of the present disclosure can be annealed during use, which may improve seal ring function by ‘breaking in’ the seal ring interfaces as annealing occurs. In addition, plated coatings may be produced on substrate materials having a predefined shape. The plated coatings will conform to the shape of the substrate materials, thereby reducing or obviating the need for additional machining to produce a desired shape and/or contour.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

1. A method of producing a metal seal ring, comprising:
selecting a seal ring substrate material; and
applying a coating to the seal ring substrate material using an electroless plating process.

2. The method of claim 1, wherein the coating includes a nickel-boron coating.

3. The method of claim 2, wherein the nickel-boron coating includes between about 1% and about 10% of boron by weight.

4. The method of claim 3, wherein the nickel-boron coating includes between about 4% and about 7% of boron by weight.

5. The method of claim 1, wherein the coating includes a nickel-phosphorous coating.

6. The method of claim 5, wherein the coating includes between about 1% and about 15% of phosphorous by weight.

7. The method of claim 6, wherein the coating includes between about 1% and about 10% of phosphorous by weight.

8. The method of claim 1, wherein the electroless plating process includes exposing a surface of the seal ring substrate to a solution containing nickel ions and a reducing agent selected from the group including sodium borohydride, dimethylamine borane, diethylamine borane, and sodium hyposphosphite.

9. The method of claim 1, further including heat treating the seal ring substrate and the coating.

10-29. (canceled)

30. A method of producing a metal seal ring, comprising:
obtaining a seal ring substrate material; and
applying a coating to the seal ring substrate material using an electroless plating process, wherein the coating comprises a nickel-boron or nickel-phosphorus coating.

31. The method of claim 30, wherein the coating includes the nickel-boron coating.

32. The method of claim 31, wherein the nickel-boron coating includes between about 1% and about 10% of boron by weight.

33. The method of claim 32, wherein the nickel-boron coating includes between about 4% and about 7% of boron by weight.

34. The method of claim 30, wherein the coating includes the nickel-phosphorous coating.

35. The method of claim 34, wherein the coating includes between about 1% and about 15% of phosphorous by weight.

36. The method of claim 35, wherein the coating includes between about 1% and about 10% of phosphorous by weight.

37. The method of claim 30, wherein the electroless plating process includes exposing a surface of the seal ring substrate to a solution containing nickel ions and a reducing agent selected from the group including sodium borohydride, dimethylamine borane, diethylamine borane, and sodium hyposphosphite.

38. The method of claim 30, further including heat treating the seal ring substrate and the coating.
